(19) United States
(12) Patent Application Publication
(10) Pub. No.: US 2021/0129634 A1
(43) Pub. Date: May 6, 2021

(54) Windshield Shade Assembly

(71) Applicant: Luel Woldemariam, Las Vegas, NV (US)

(72) Inventor: Luel Woldemariam, Las Vegas, NV (US)

(21) Appl. No.: 16/669,706

(22) Filed: Oct. 31, 2019

(51) Int. Cl. B60J 1/20

(52) U.S. Cl. CPC B60J 1/2025; B60J 1/205; B60J 1/2077

(57) ABSTRACT

A windshield shade assembly includes a spool that is mountable on a dashboard of a vehicle to extend along a windshield of the vehicle. A curtain is wrapped around the spool and the curtain is extendable over the windshield for shading an interior of the vehicle. A pair of motors is each in communication with the spool and the motors rotates the spool for extending and retracting the curtain. A control is positioned in the vehicle such that the control is accessible to a driver. The control is electrically coupled to each of the motors for extending and retracting the curtain. Moreover, the control is in remote communication with a personal electronic device thereby facilitating the personal electronic device to remotely control each of the motors.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shade devices and more particularly pertains to a new shade device for automatically covering a windshield in a vehicle.

### (2) Description of Related Art Including Information Disclosed Under 37 CFR 1.97 and 1.98

The prior art relates to shade devices.

### BRIEF SUMMARY OF THE INVENTION

An embodiment of the disclosure meets the needs presented above by generally comprising a spool that is mountable on a dashboard of a vehicle to extend along a windshield of the vehicle. A curtain is wrapped around the spool and the curtain is extendable over the windshield for shading an interior of the vehicle. A pair of motors is each in communication with the spool and the motors rotates the spool for extending and retracting the curtain. A control is positioned in the vehicle such that the control is accessible to a driver. The control is electrically coupled to each of the motors for extending and retracting the curtain. Moreover, the control is in remote communication with a personal electronic device thereby facilitating the personal electronic device to remotely control each of the motors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an interior view of a windshield shade assembly according to an embodiment of the disclosure showing a curtain being wrapped around a spool.

FIG. 2 is an interior view of an embodiment of the disclosure showing a curtain being drawn off of a spool.

FIG. 3 is a cross sectional view taken along line 3-3 of FIG. 1 of an embodiment of the disclosure.

FIG. 4 is an exterior view of an embodiment of the disclosure.

FIG. 5 is a schematic view of an embodiment of the disclosure.

### DETAILED DESCRIPTION OF THE INVENTION

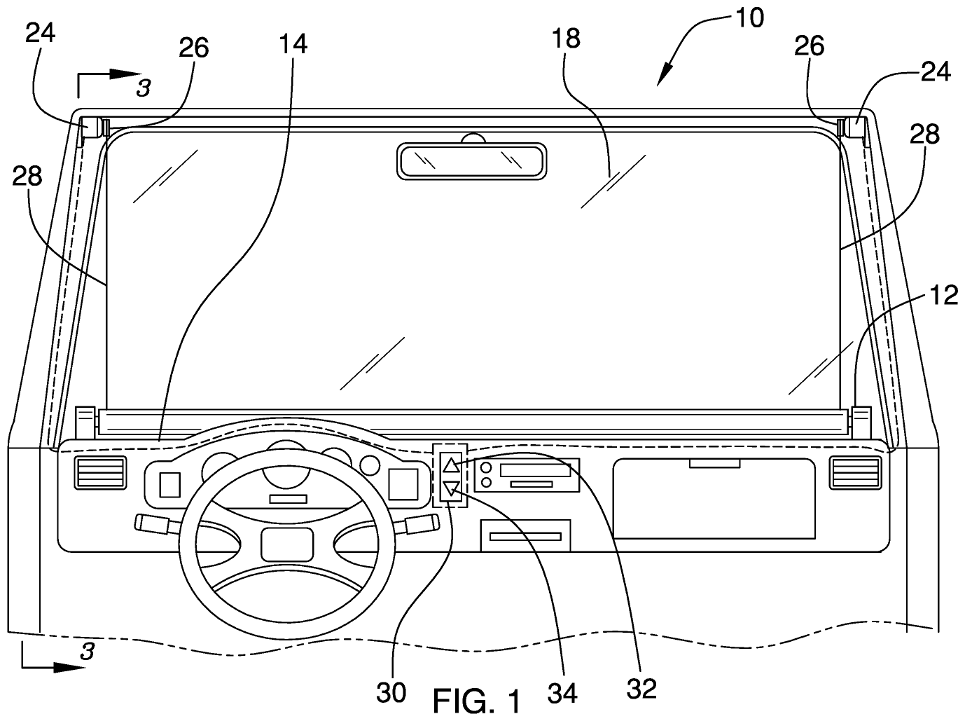

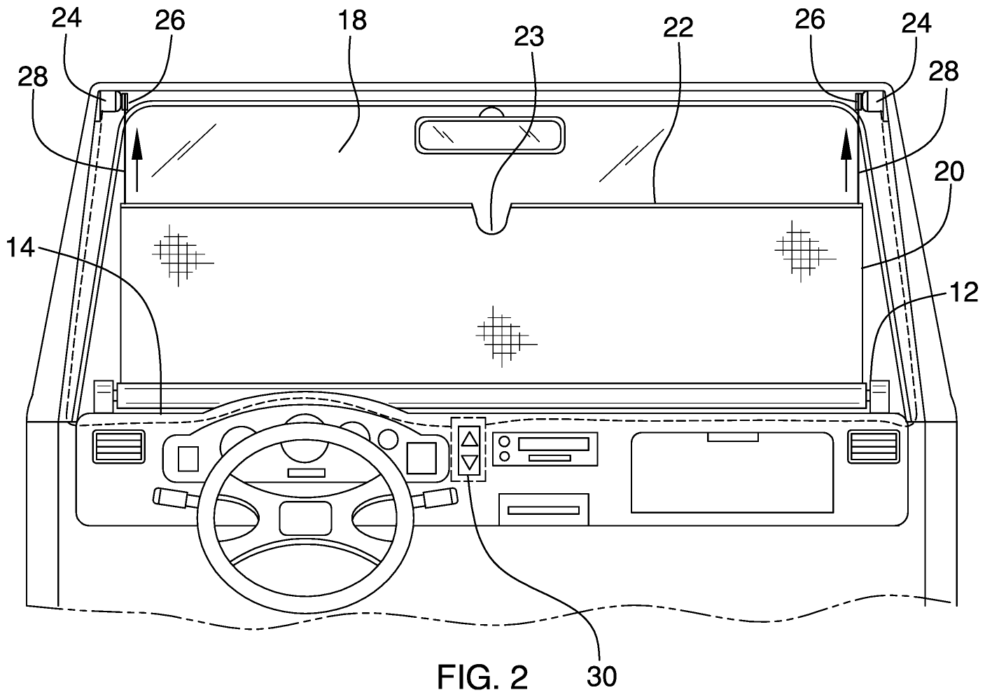

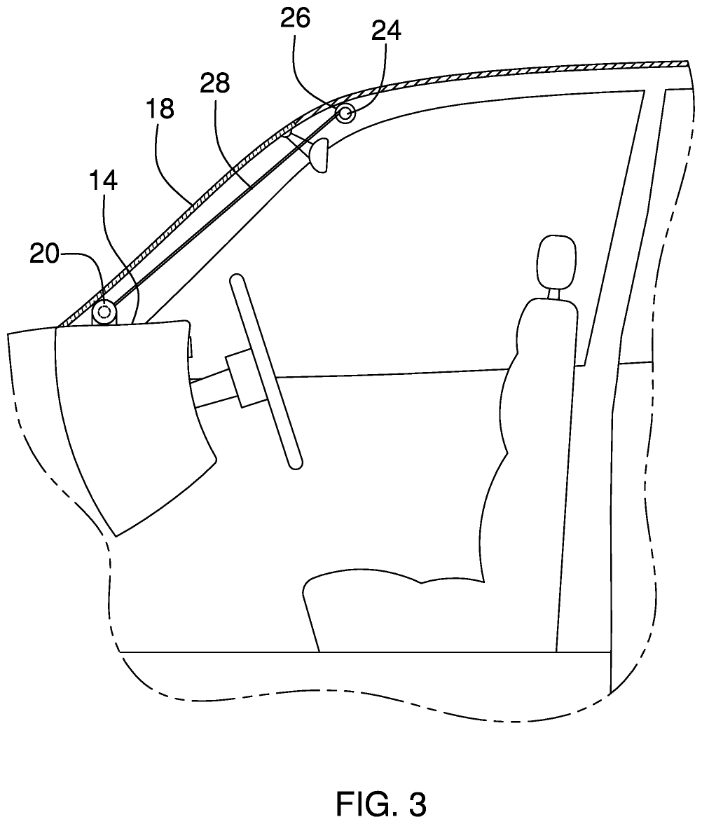

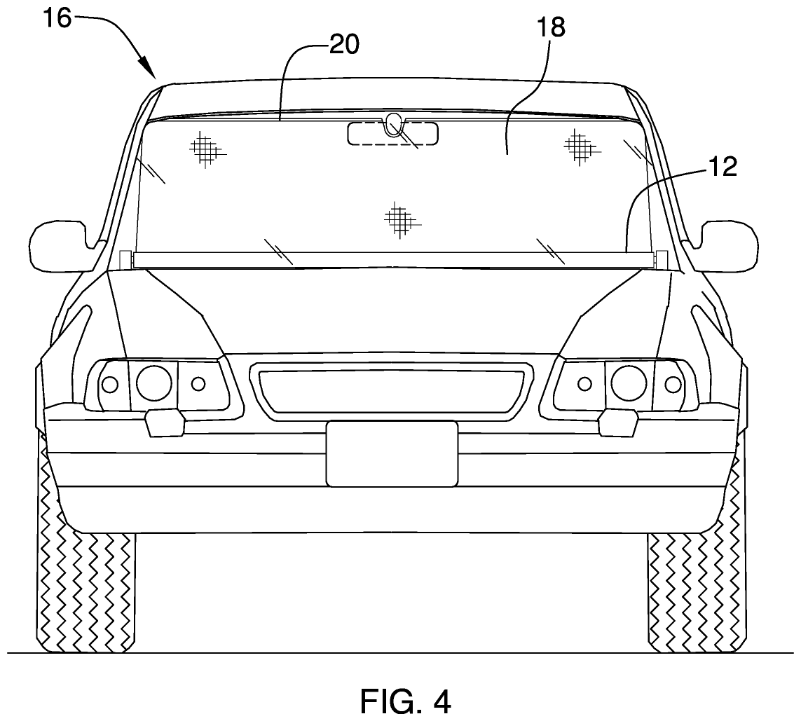

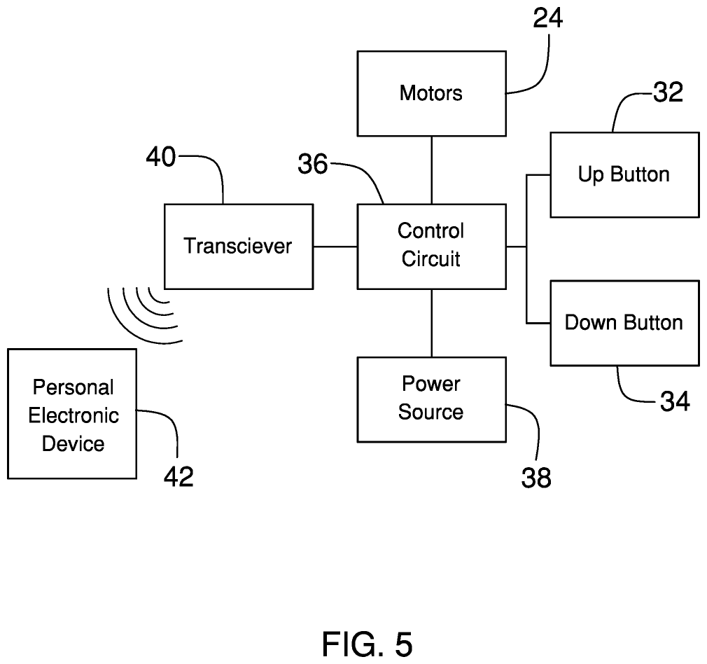

With reference now to the drawings, and in particular to FIGS. 1 through 5 thereof, a new shade device embodying the principles and concepts of an embodiment of the disclosure and generally designated by the reference numeral 10 will be described.

As best illustrated in FIGS. 1 through 5, the windshield shade assembly 10 generally comprises a spool 12 that is mountable on a dashboard 14 of a vehicle 16 having the spool 12 being oriented to extend along a windshield 18 of the vehicle 16. The spool 12 is rotatable in a first direction or a second direction, and the spool 12 is biased to rotate in the first direction. The spool 12 may be a spring loaded spool or the like. Additionally, the spool 12 may have a length that is equal to the width of the windshield 18. The vehicle 16 may be a passenger vehicle, a cargo vehicle or any other motorized vehicle that can be driven on public roadways.

A curtain 20 is provided and the curtain 20 is wrapped around the spool 12. The curtain 20 is extendable over the windshield 18 for shading an interior of the vehicle 16. Additionally, the curtain 20 is wrappable around the spool 12 such that the windshield 18 is exposed. The curtain 20 has a distal edge 22 with respect to the spool 12 and the curtain 20 is comprised of an opaque material. Moreover, the curtain 20 is wrapped around the spool 12 when the spool 12 rotates in the first direction and the curtain 20 is unwrapped from the spool 12 when the spool 12 rotates in the second direction. The distal edge 22 may have a cut out 23 for accommodating a rear view mirror on the windshield 18.

A pair of motors 24 is provided and each of the motors 24 is positioned within the interior of the vehicle 16. Each of the motors 24 is in communication with the spool 12 and the motors 24 rotate the spool 12 for extending and retracting the curtain 20. Each of the motors 24 is positioned on opposite sides of the windshield 18 and each of the motors 24 is aligned with an upper threshold of the windshield 18. Each of the motors 24 rotates in a first direction when the motors 24 are turned on and each of the motors 24 is rotatable in a second direction when the motors 24 are turned off. Additionally, each of the motors 24 may comprise electric motors or the like.

A pair of pulleys 26 is provided and each of the pulleys 26 is rotatably coupled to a respective one of the motors 24 such that the motors 24 rotate the pulleys 26 when the motors 24 are turned on. A pair of cables 28 is each coupled between the distal edge 22 of the curtain 20 and a respective one of the pulleys 26. Each of the cables 28 is wrapped around the respective pulley 26 when the motors 24 are turned on to rotate in the first direction. In this way the curtain 20 is drawn over the windshield 18. Additionally, the curtain 20 is wrapped around the spool 12 when the motors 24 are turned off.

A control 30 is positioned in the vehicle 16 such that the control 30 is assessable to a driver. The control 30 is electrically coupled to each of the motors 24 and the control 30 includes an up button 32 and a down button 34. Each of the motors 24 is turned on when the up button 32 is depressed and each of the motors 24 is turned off when the down button 34 is depressed. A control circuit 36 is positioned in the control 30 and the control circuit 36 is electrically coupled to the control 30 and each of the motors 24. The control circuit 36 is electrically coupled to a power source 38 comprising an electrical system of the vehicle 16.

A transceiver 40 is included, the transceiver 40 is positioned in the control 30 and the transceiver 40 is electrically coupled to the control circuit 36. The transceiver 40 is in wireless communication with a personal electronic device 42 thereby facilitating the personal electronic device 42 to remotely control 30 the motors 24. The personal electronic device 42 may be a smart phone or other similar device, and the personal electronic device 42 may store software, such as a smart phone app, for controlling the motors 24. The transceiver 40 may be a radio frequency transceiver or the like.

In use, the up button 32 is depressed to draw the curtain 20 upwardly for covering the windshield 18. In this way the curtain 20 shades the interior of the vehicle 16 for reducing interior temperature of the vehicle 16 during periods of sunlight. The down button 34 is depressed for retracting the curtain 20 and subsequently exposing the windshield 18. Additionally, the curtain 20 can be extended over the windshield 18 or retracted by using the personal electronic device 42 as a remote control. Thus, the windshield 18 can be shaded without requiring a barrier to be placed on the dashboard 14 for shading the windshield 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A windshield shade assembly being configured to be automatically deployed over a windshield for shading an interior of a vehicle, said assembly comprising:
a spool being mountable on a dashboard of a vehicle having said spool being oriented to extend along a windshield of the vehicle;
a curtain being wrapped around said spool, said curtain being extendable over the windshield for shading an interior of the vehicle, said curtain being wrappable around said spool such that the windshield is exposed;
a pair of motors, each of said motors being positioned within the interior of the vehicle, each of said motors being in communication with said spool, said motors rotating said spool for extending and retracting said curtain; and
a control being positioned in the vehicle such that said control is accessible to a driver, said control being electrically coupled to each of said motors for extending and retracting said curtain, said control being in remote communication with a personal electronic device thereby facilitating the personal electronic device to remotely control each of said motors.

2. The assembly according to claim 1, wherein:
said spool is rotatable in a first direction or a second direction, said spool being biased to rotate in said first direction; and
said curtain has a distal edge with respect to said spool, said curtain being comprised of an opaque material, said curtain being wrapped around said spool when said spool rotates in said first direction, said curtain being unwrapped from said spool when said spool rotates in said second direction.

3. The assembly according to claim 2, wherein each of said motors is positioned on opposite sides of the windshield, each of said motors being aligned with an upper threshold of the windshield, each of said motors rotating in a first direction when said motors are turned on, each of said motors being rotatable in a second direction when said motors are turned off.

4. The assembly according to claim 3, further comprising a pair of pulleys, each of said pulleys being rotatably coupled to a respective one of said motors such that said motors rotate said pulleys when said motors are turned on.

5. The assembly according to claim 4, further comprising a pair of cables, each of said cables being coupled between said distal edge of said curtain and a respective one of said pulleys, each of said cables being wrapped around said respective pulley when said motors are turned on to rotate in said first direction such that said curtain is drawn over the windshield, said curtain being wrapped around said spool when said motors are turned off.

6. The assembly according to claim 1, wherein said control includes an up button and a down button, each of said motors being turned on when said up button is depressed; each of said motors being turned off when said down button is depressed.

7. The assembly according to claim 6, further comprising a control circuit being positioned in said control, said control circuit being electrically coupled to said control and each of said motors, said control circuit being electrically coupled to a power source comprising an electrical system of the vehicle.

8. The assembly according to claim 7, further comprising a transceiver being positioned in said control, said transceiver being electrically coupled to said control circuit, said transceiver being in wireless communication with a personal electronic device thereby facilitating the personal electronic device to remotely control said motors.

9. A windshield shade assembly being configured to be automatically deployed over a windshield for shading an interior of a vehicle, said assembly comprising:
a spool being mountable on a dashboard of a vehicle having said spool being oriented to extend along a windshield of the vehicle, said spool being rotatable in a first direction or a second direction, said spool being biased to rotate in said first direction;
a curtain being wrapped around said spool, said curtain being extendable over the windshield for shading an interior of the vehicle, said curtain being wrappable around said spool such that the windshield is exposed, said curtain having a distal edge with respect to said spool, said curtain being comprised of an opaque material, said curtain being wrapped around said spool when said spool rotates in said first direction, said curtain being unwrapped from said spool when said spool rotates in said second direction;
a pair of motors, each of said motors being positioned within the interior of the vehicle, each of said motors being in communication with said spool, said motors rotating said spool for extending and retracting said curtain, each of said motors being positioned on opposite sides of the windshield, each of said motors being aligned with an upper threshold of the windshield, each of said motors rotating in a first direction when said motors are turned on, each of said motors being rotatable in a second direction when said motors are turned off;
a pair of pulleys, each of said pulleys being rotatably coupled to a respective one of said motors such that said motors rotate said pulleys when said motors are turned on;
a pair of cables, each of said cables being coupled between said distal edge of said curtain and a respective one of said pulleys, each of said cables being wrapped around said respective pulley when said motors are turned on to rotate in said first direction such that said curtain is drawn over the windshield, said curtain being wrapped around said spool when said motors are turned off;
a control being positioned in the vehicle such that said control is accessible to a driver, said control being electrically coupled to each of said motors, said control including an up button and a down button, each of said motors being turned on when said up button is depressed, each of said motors being turned off when said down button is depressed;
a control circuit being positioned in said control, said control circuit being electrically coupled to said control and each of said motors, said control circuit being electrically coupled to a power source comprising an electrical system of the vehicle; and
a transceiver being positioned in said control, said transceiver being electrically coupled to said control circuit, said transceiver being in wireless communication with a personal electronic device thereby facilitating the personal electronic device to remotely control said motors.
